(19) United States
(12) Patent Application Publication
(10) Pub. No.: US 2002/0162432 A1
(43) Pub. Date: Nov. 7, 2002

(54) Wood-turning lathe

(76) Inventor: Juei-Seng Liao, Taichung City (TW)

Correspondence Address: CHRISTIE, PARKER & HALE, LLP, 350 WEST COLORADO BOULEVARD, SUITE 500, PASADENA, CA, 91105, US

(21) Appl. No.: 09/882,350

(22) Filed: Jun. 15, 2001

(30) Foreign Application Priority Data
May 1, 2001 (TW) 090207042

(51) Int. Cl. B23B 19/00

(52) U.S. Cl. 82/142; 142/1

(57) ABSTRACT

A wood-turning lathe includes a driven shaft and a drive shaft journalled on a headstock body. A speed change device includes a first pulley unit mounted on the drive shaft, and having a first fixed pulley and a first movable pulley that cooperatively define therebetween a first belt receiving space and that form a radially and outwardly diverging first belt-engaging surface. A control unit has an operable knob which is exposed from the headstock body and which is operably associated with the first movable pulley. A second pulley unit is mounted on the driven shaft, and has a second fixed pulley and a second movable pulley which cooperatively define therebetween a second belt receiving space and which form a radially and outwardly diverging second belt-engaging surface. A non-elastic belt interconnects the first and second pulley units, and is frictionally slidable along the first and second belt-engaging surfaces.

### CROSS-REFERENCE TO RELATED APPLICATION

This application claims priority of Taiwan Application No. 90207042, filed Jan. 5, 2001.

### BACKGROUND OF THE INVENTION

1. Field of the Invention

The invention relates to a wood-turning lathe, more particularly to a wood-turning latch with a noiseless speed changing device for a driven shaft.

2. Description of the Related Art

Referring to FIG. 1, a conventional wood-turning lathe 10 is shown to include a lathe bed 11 upon which are mounted a headstock 12, a tail-stock 13, and a tool rest 14 between the headstock 12 and the tail-stock 13. The headstock 12 includes a shaft that is rotated by a motor 16, and has an output end 15 for holding one end of the wood (not shown) to be turned. The tail-stock 13 holds the other end of the wood (not shown), allowing the latter to rotate freely. A chisel (not shown) is fixed on the tool rest 14 for shaping and cutting the wood (not shown) during rotation of the latter.

A speed change device 17, consisting of a plurality of different gears, is operably coupled to the motor 16 for changing the rotation speed of the output end 15 of the shaft. It is noted that the noise generated during the gear change is loud and annoys the operator of the conventional wood-turning lathe.

### SUMMARY OF THE INVENTION

Therefore, the object of this invention is to provide a wood-turning lathe which includes a noiseless speed change device for changing the rotation speed of an output end of a driven shaft.

Accordingly, a wood-turning lathe of the present invention includes a lathe bed on which are mounted a headstock, a tail-stock, and a tool rest between the headstock and the tail-stock. The headstock includes a headstock body, a driven shaft, a drive shaft, and a speed change device. The driven shaft is journalled to the headstock body, and has an output end which extends outwardly from the headstock body. The drive shaft is journalled to the headstock body, and is vertically spaced apart from and extends parallel to the driven shaft. The drive shaft has a coupling end that extends outwardly from the headstock body. The speed change device includes a first pulley unit, a control unit, a second pulley unit, and a non-elastic belt. The first pulley unit is mounted on the coupling end of the drive shaft, and has a first fixed pulley and a first movable pulley. The first fixed and movable pulleys cooperatively define therebetween a first belt receiving space and form a a radially and outwardly diverging first belt-engaging surface that confines the first belt receiving space. The control unit is mounted on the headstock body, and has an operable knob which is exposed from the headstock body and which is operably associated with the first movable pulley. The second pulley unit is mounted on the output end of the driven shaft, and has a second fixed pulley and a second movable pulley which cooperatively define therebetween a second belt receiving space and which form a radially and outwardly diverging second belt-engaging surface that confines the second belt receiving space. The second pulley unit further has an urging member that urges the second movable pulley toward the second fixed pulley. The non-elastic belt interconnects the first and second pulley units, and is frictionally slidable along the first and second belt-engaging surfaces of the first and second pulley units. The belt cooperates with the drive shaft to define a first radial distance therebetween, and with the driven shaft to define a second radial distance therebetween.

Rotation of the operable knob causes axial movement of the first movable pulley along the drive shaft toward and away from the first fixed pulley and consequently results in movements of the belt along the first and second belt-engaging surfaces within the first and second belt receiving spaces, thereby varying the first and second radial distances.

Since no gear wheels are used in the speed change device of the present wood-turning lathe, generation of noise due to gear meshing as encountered in the conventional wood-turning lathe can be eliminated

### BRIEF DESCRIPTION OF THE DRAWINGS

Other features and advantages of this invention will become more apparent in the following detailed description of the preferred embodiment of this invention, with reference to the accompanying drawings, in which:

FIG. 1 is a perspective view of a conventional wood-turning lathe;

FIG. 2 is a fragmentary perspective view of the preferred embodiment of a wood-turning lathe according to the present invention;

FIG. 3 is a partly exploded perspective view of the preferred embodiment;

FIG. 4 is a fragmentary sectional view of the preferred embodiment;

FIG. 5 is a fragmentary partly sectional schematic top view of the preferred embodiment taken along lines V-V in FIG. 2, illustrating a control unit employed therein;

FIG. 6 is an another fragmentary partly sectional schematic top view of the preferred embodiment in FIG. 5, illustrating how the control unit is activated to move a movable pulley relative a fixed pulley;

FIG. 7 is a fragmentary sectional view of the preferred embodiment, illustrating a first condition where an output end of a driven shaft is rotated at a high speed;

FIG. 8 is a fragmentary sectional view of the preferred embodiment, illustrating a second condition where the output end of the driven shaft is rotated at a slow speed;

FIG. 9 is an exploded view of a locking device employed in the preferred embodiment for locking a headstock on a lathe bed; and

FIGS. 10 and 11 are fragmentary sectional views of the preferred embodiment, illustrating how the headstock is locked and unlocked on the lathe bed by means of the locking device shown in FIG. 9.

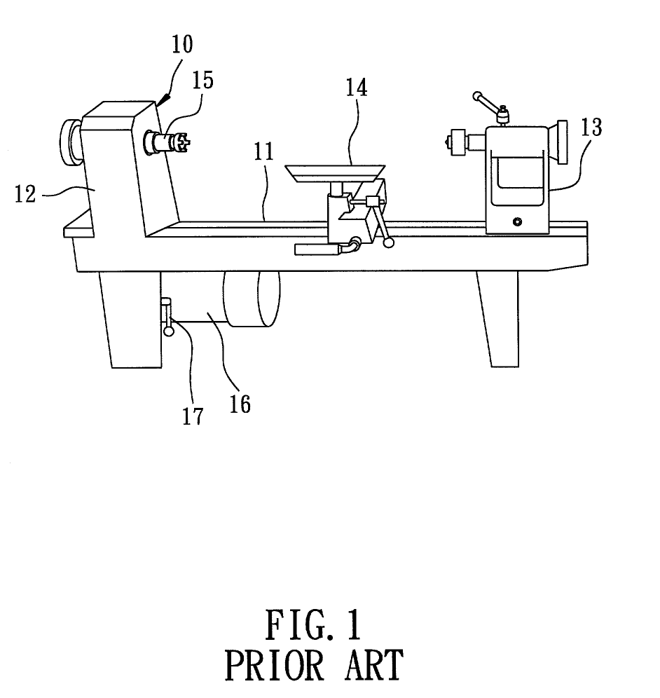

### DETAILED DESCRIPTION OF THE PREFERRED EMBODIMENT

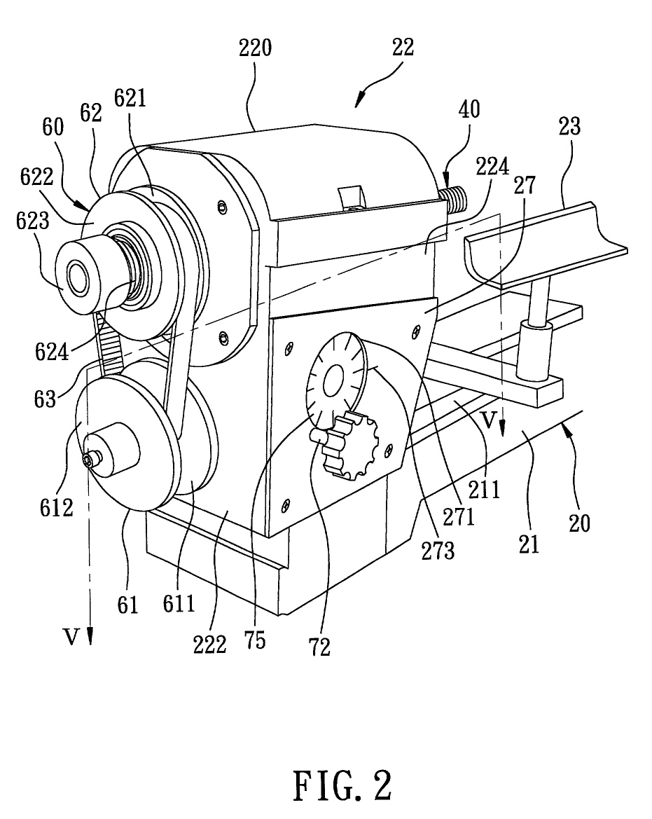

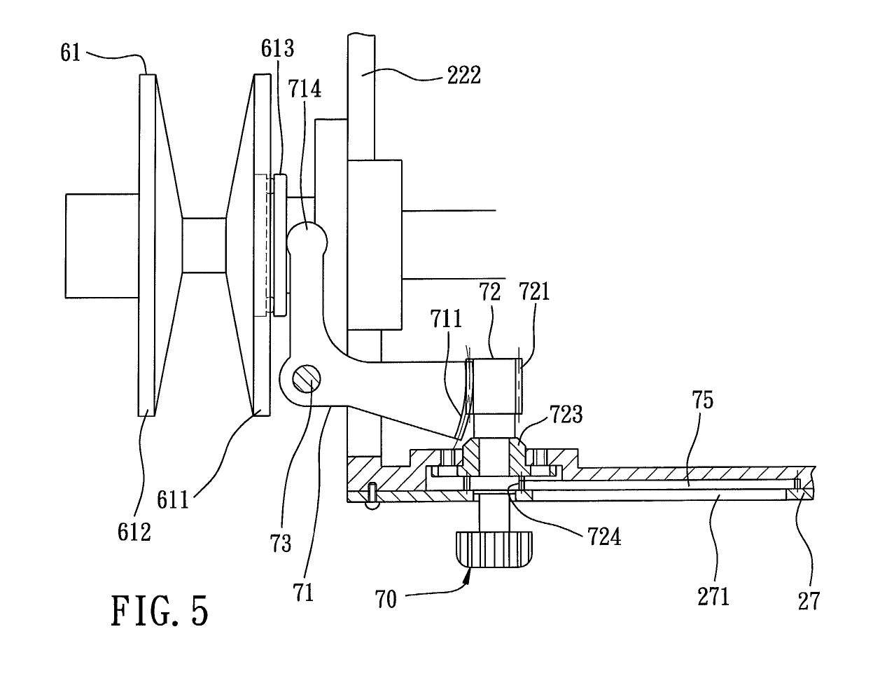

Referring to FIGS. 2 to 5, the preferred embodiment of a wood-turning lathe 20 according to the present invention is shown to include a lathe bed 21 on which are mounted a headstock 22, a tail-stock (not shown), and a tool rest 23 between the headstock 22 and the tail-stock. The present invention is related to improvements upon the headstock 22, which includes a headstock body 220, a driven shaft 40, a drive shaft 50, and a speed change device 60.

As illustrated, the headstock body 220 has a flat bottom 221 mounted on the upper surface 211 of the lathe bed 21, and opposite left and right side walls 222, 223 which extend upwardly from the flat bottom 221.

The driven shaft 40 is journalled between the side walls 222, 223 of the headstock body 220 by means of two bearing units 24,25, and has an output end 43 that extends outwardly from the headstock body 220.

The drive shaft 50 is journalled to the headstock body 220 by means of two bearing units (613, 226), and is vertically spaced apart from and extends parallel to the driven shaft 40. The drive shaft 50 has an outer coupling end 53 extending outwardly from the headstock body 220, and an inner coupling end 52 disposed within the headstock body 220, the purpose of which will be explained in the following paragraphs.

The speed change device 60 includes a first pulley unit 61, a control unit 70, a second pulley unit 62, and a non-elastic belt 63. The first pulley unit 61 is mounted on the outer coupling end 53 of the drive shaft 50, and has a first fixed pulley 612 and a first movable pulley 611. The first fixed and movable pulleys 612, 611 cooperatively define therebetween a first belt receiving space and form a radially and outwardly diverging first belt-engaging surface (6111, 6121) that confines the first belt receiving space. The control unit 70 is mounted on the headstock body 220, and has an operable knob 72 exposed from the headstock body 220. The operable knob 72 is operably associated with the first movable pulley 611. The second pulley unit 62 is mounted on the output end 43 of the driven shaft 40, and has a second fixed pulley 621 and a second movable pulley 622 which cooperatively define therebetween a second belt receiving space and which form a radially and outwardly diverging second belt-engaging surface (6211, 6212) that confines the second belt receiving space. The second pulley unit 62 further has an urging member 624, in the form of a coil spring, for urging the second movable pulley 622 toward the second fixed pulley 621. The non-elastic belt 63 interconnects the first and second pulley units 61, 62 in such a manner that the belt 63 is frictionally slidable along the first and second belt-engaging surfaces (6111,6121), (6211, 6212) and cooperates with the drive shaft 50 to define a first radial distance (L1) therebetween, and with the driven shaft 40 to define a second radial distance (L2) therebetween. Under this condition, operation of the operable knob 72 causes axial movement of the first movable pulley 611 along the drive shaft 50 toward and away from the first fixed pulley 612 and consequently results in movements of the belt 63 along the first and second belt-engaging surfaces (6111,6121), (6211,6212) within the first and second belt receiving spaces, thereby varying the first and second radial distances (L1, L2).

In the preferred embodiment, the operable knob 72 has a first threaded end 721. The control unit 70 further includes a C-shaped bearing seat 26 fixed in a mounting hole 2221 of the left side wall 222 of the headstock body 220 so as to be disposed around the drive shaft 50 between the first movable pulley 611 and the operable knob 72. The bearing seat 26 has spaced apart two ends 264. A crank element 71 is pivoted to the ends 264 of the bearing seat 26 by a pivot pin 73 so as to be turnable relative to the ends 264. The crank element 71 has a second threaded end 711 threadedly engaging the first threaded end 721 of the operable knob 72, and a U-shaped push end 714 which abuts engageably against the movable pulley 611 so that operation of the operable knob 72 results in swinging action of the U-shaped push end 714 relative to the seat 26, which in turn, results in movement of the first movable pulley 611 toward and away from the first fixed pulley 612.

In the preferred embodiment, a motor 30 is disposed on a motor support 225 within the headstock body 220, and includes a stator 31, a rotor 32, and a hollow driving shaft 34 which is coupled with a threaded end 33 of the rotor 32. The driven shaft 40 extends through the driving shaft 34. A pair of pulleys 521,341 are mounted on the driving shaft 34 and the outer coupling end 52 of the drive shaft 50. A transmission belt 54 is trained on the pulleys 521,341 to transmit rotation of the driving shaft 34 to the drive shaft 50.

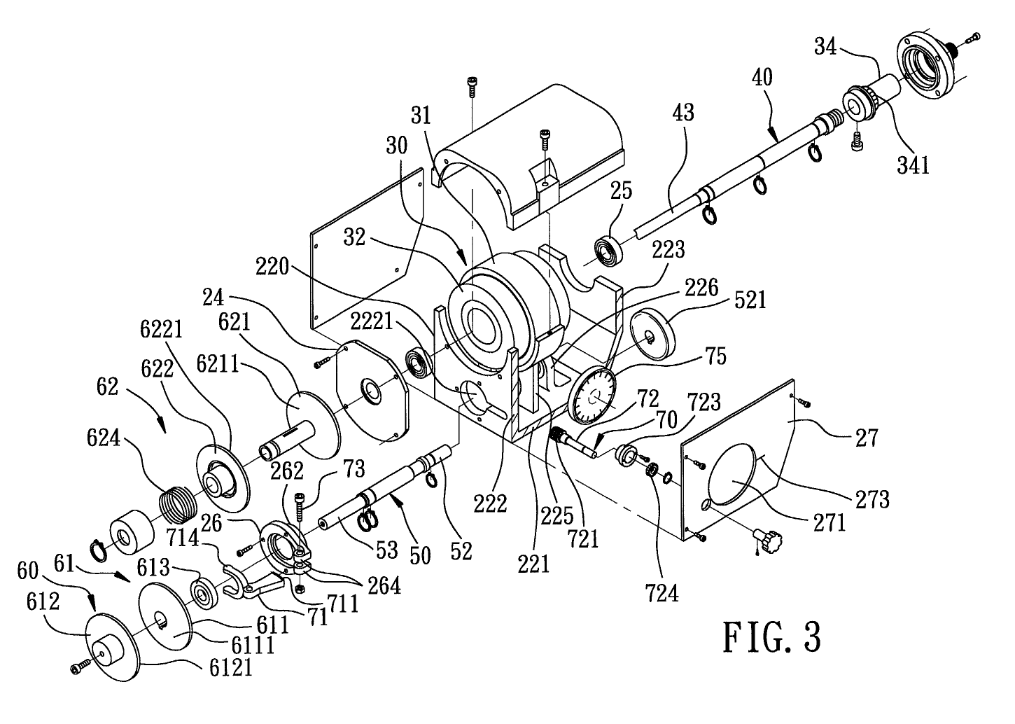

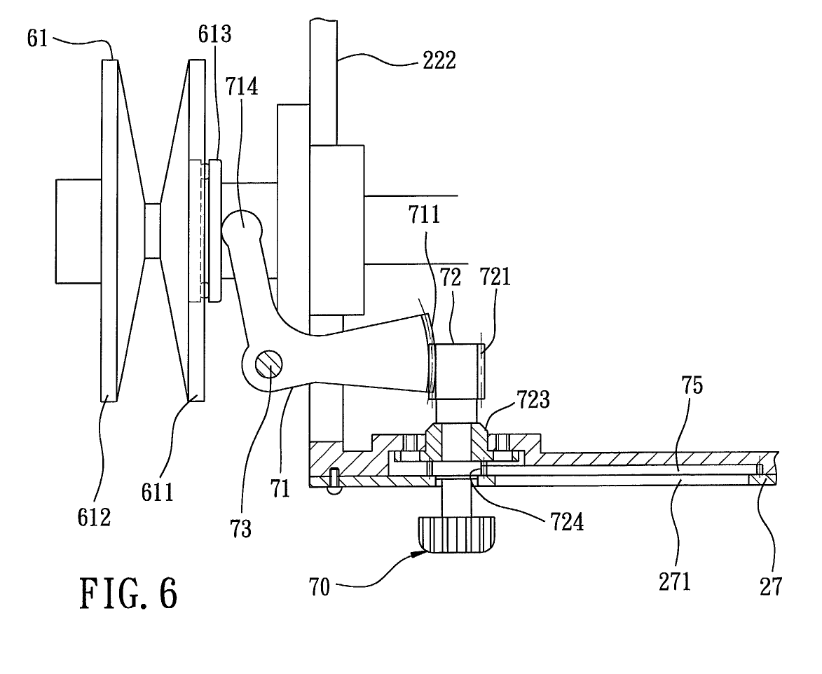

Referring to FIGS. 3, 5 and 6, the headstock body 220 has a front wall 27 formed with a dial opening 271. A bushing 723 is fixed on the wall 27. A dial 75 is rotatably mounted on the wall 27, is exposed from the dial opening 271, and is operably connected to the operable knob 72 via the bushing 723 and a toothed wheel 724 such that the dial 75 cooperates with an indicating mark 273 on the wall 27 to show the speed of the driven shaft 40 upon rotation of the operable knob 72.

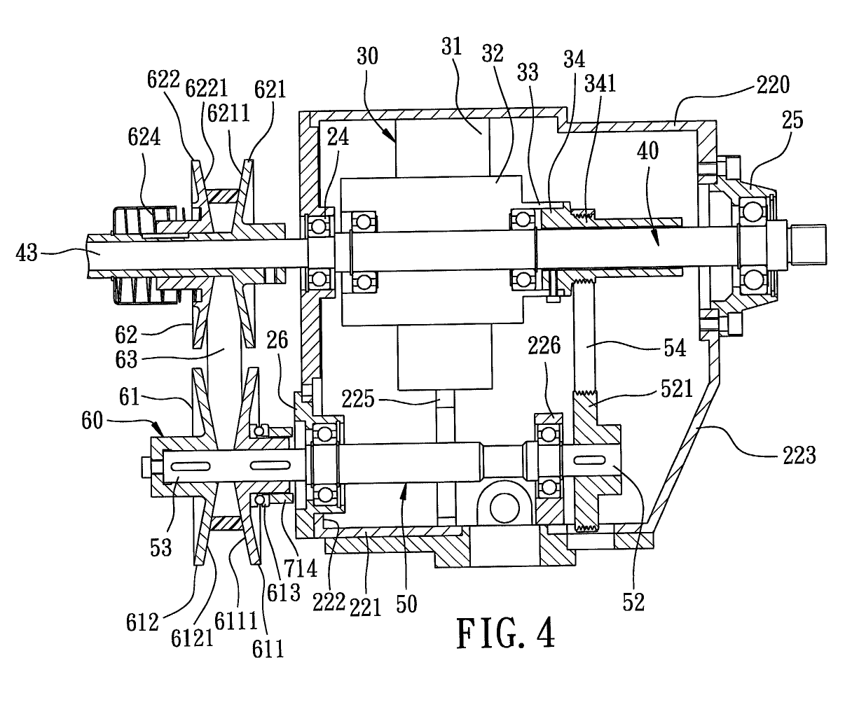

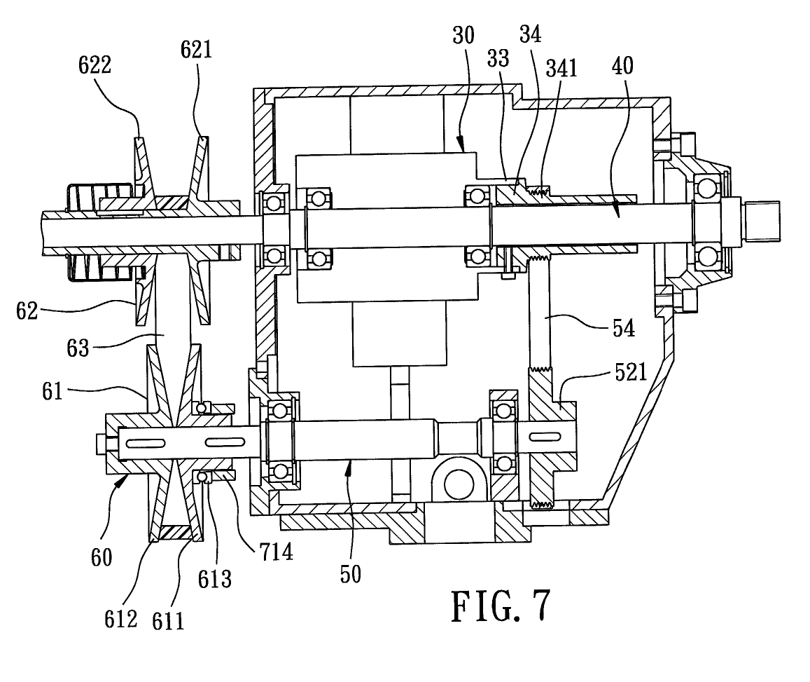

Referring to FIGS. 4 and 7, when it is desired to increase the rotation speed of the driven shaft 40, the operable knob 72 can be turned in a first direction so as to rotate the crank element 71 and move the first movable pulley 611 on the drive shaft 50 toward the first fixed pulley 612. Under this condition, the belt 63 is moved downwardly along the first and second belt-engaging surfaces (6111,6121), (6211,6212), which results in an increase in the first radial distance (L1) and a decrease in the second radial distance (L2). As a consequence, the pulley units 61,62 act like a large gear that drives a small gear, thereby permitting the driven shaft 40 to have a higher speed than that of the drive shaft 50.

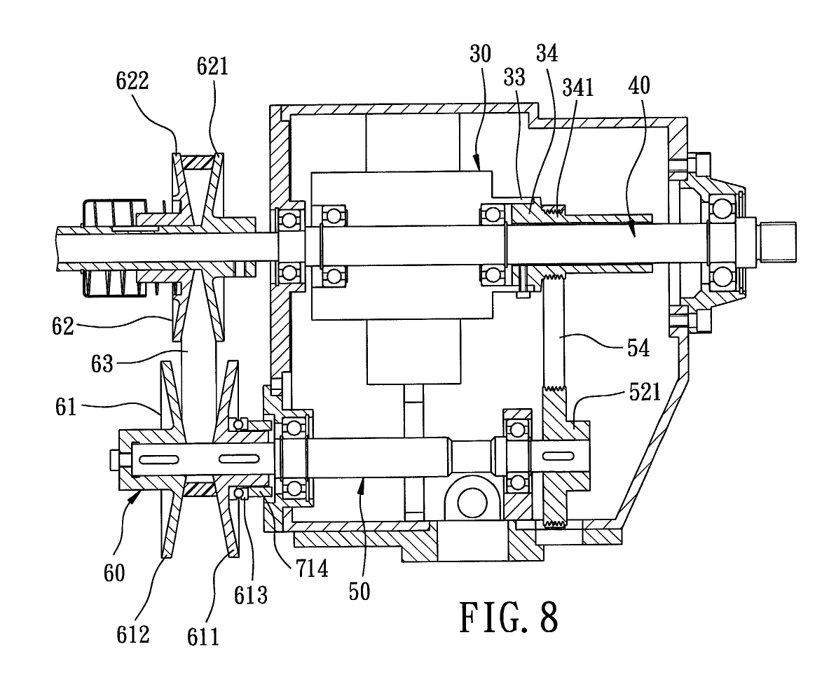

Referring to FIGS. 4 and 8, when it is desired to decrease the rotation speed of the driven shaft 40, the operable knob 72 can be turned in a second direction opposite to the first direction so as to move the first movable pulley 611 on the drive shaft 50 away from the first fixed pulley 612. Under this condition, the belt 63 moves upwardly along the first and second belt-engaging surfaces (6111,6121), (6211,6212), which results in a decrease in the first radial distance (L1) and an increase in the second radial distance (L2). As a consequence, the pulley units 61, 62 acts like a small gear that drives a large gear, thereby permitting the driven shaft 40 to have a lower speed than that of the drive shaft 50.

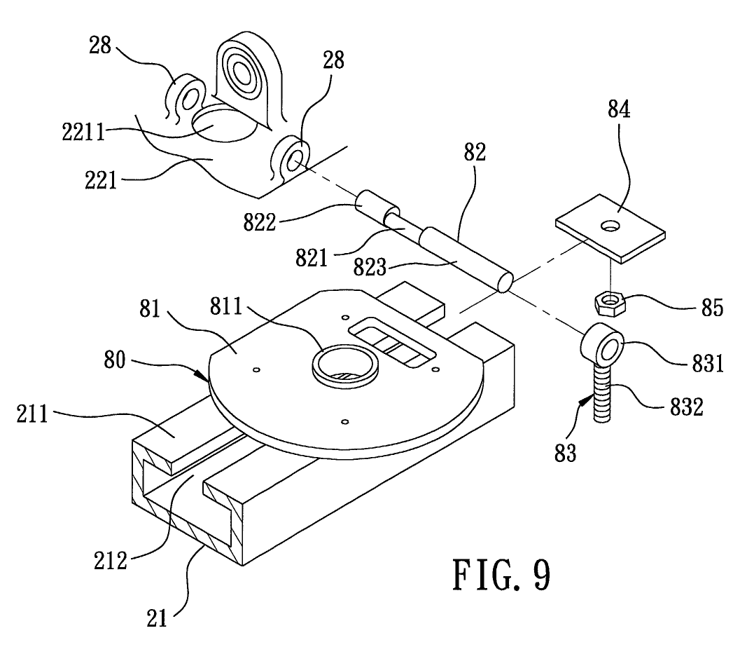

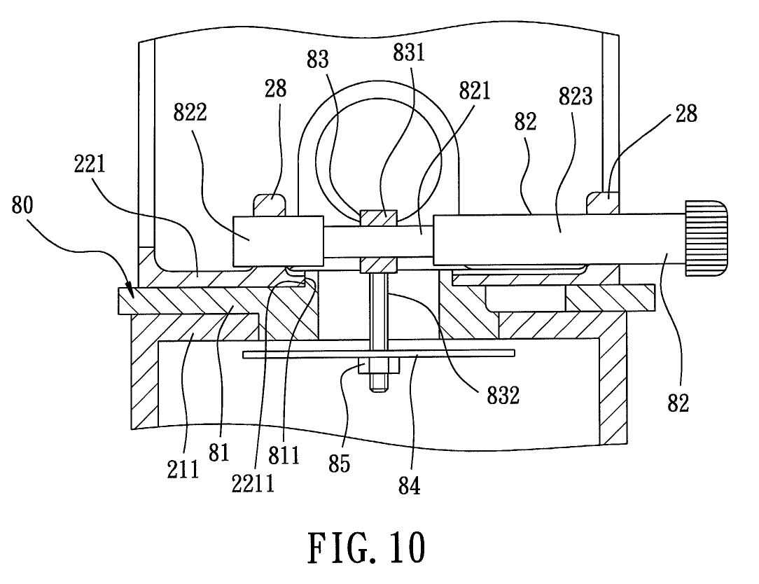

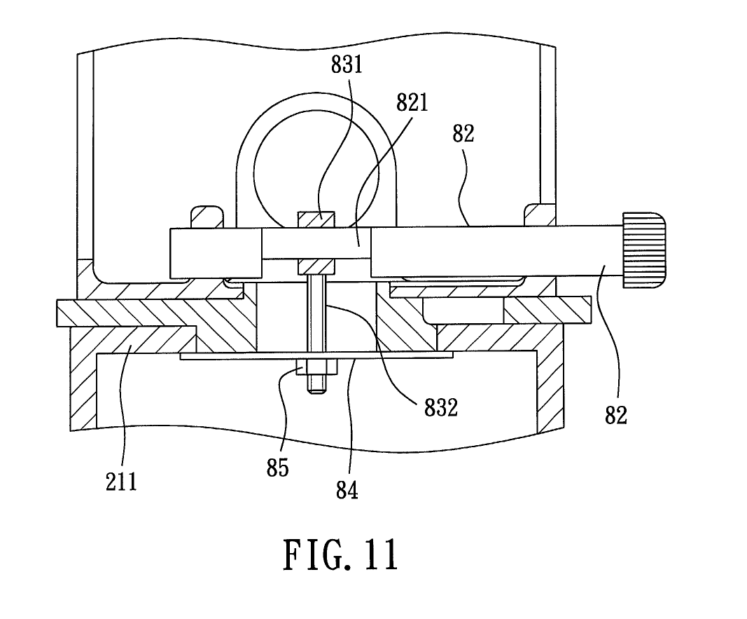

Referring to FIGS. 9, 10 and 11, a releasable locking device 80 is provided between the flat bottom 221 of the headstock body 220 and the lathe bed 21. The locking device 80 includes a mounting disc 81 which is disposed over the lathe bed 21 and which is formed with an annular flange 811 projecting upwardly through a circular hole 2211 in the flat bottom 221 of the headstock body 220, a regulating rod 82 which has opposite end sections 822,823 pivoted to two ears 28 that project upwardly from the flat bottom 221, a middle section 821 disposed between and eccentric relative to the end sections 822,823, and a fastener unit 83. The fastener unit 83 includes a tubular sleeve 831 sleeved on the middle section 821, and a threaded shaft 832 which extends integrally from the sleeve 831 and through the flange 811 of the disc 81 into a groove 212 of the lathe bed 21, and which engages a tightening member that includes a nut 85 and a plate 84. Rotation of the regulating rod 82 in a first direction results in locking of the flat bottom 221 of the headstock body 22 on the mounting disc 81. To release the headstock body 22 from the disc 81, the regulating rod 82 can be turned in a second direction opposite to the first direction.

Since no gear wheels are employed in the wood-turning lathe of the present invention, no noise is generated when changing the rotation speed of the driven shaft. Thus, the aforesaid drawbacks as encountered in the prior art can be eliminated.

With this invention thus explained, it is apparent that numerous modifications and variations can be made without departing from the scope and spirit of this invention. It is therefore intended that this invention be limited only as indicated in the appended claims.

I claim:

1. A wood-turning lathe including a bed on which are mounted a headstock, a tail-stock, and a tool rest between the headstock and the tail-stock, wherein the headstock comprises:
a headstock body;
a driven shaft journalled to said headstock body, and having an output end extending outwardly from said headstock body;
a drive shaft journalled to said headstock body, and vertically spaced apart from and extending parallel to said driven shaft, said drive shaft having a coupling end extending outwardly from said headstock body; and
a speed change device including
a first pulley unit mounted on said coupling end of said drive shaft, and having a first fixed pulley and a first movable pulley, said first fixed and movable pulleys cooperatively defining therebetween a first belt receiving space and forming a radially and outwardly diverging first belt-engaging surface that confines said first belt receiving space,
a control unit mounted on said headstock body, and having an operable knob exposed from said headstock body and operably associated with said first movable pulley of said first pulley unit,
a second pulley unit mounted on said output end of said driven shaft, and having a second fixed pulley and a second movable pulley which cooperatively define therebetween a second belt receiving space and which form a radially and outwardly diverging second belt-engaging surface that confines said second belt receiving space, said second pulley unit further having an urging member for urging said second movable pulley toward said second fixed pulley, and
a non-elastic belt interconnecting said first and second pulley units, and being frictionally slidable along said first and second belt-engaging surfaces and cooperating with said drive shaft to define a first radial distance therebetween, and with said driven shaft to define a second radial distance therebetween;
whereby, rotation of said operable knob causes axial movement of said first movable pulley along said drive shaft toward and away from said first fixed pulley and consequently results in movements of said belt along said first and second belt-engaging surfaces within said first and second belt receiving spaces, thereby varying said first and second radial distances.

2. The wood-turning lathe as defined in claim 1, wherein said operable knob has a first threaded end, said control unit further having a bearing seat which is disposed around said drive shaft between said first movable pulley and said operable knob and which has spaced apart two ends, and a crank element pivoted to and turnable relative to said ends of said bearing seat, said crank element having a second threaded end threadedly engaging said first threaded end of said operable knob, and a U-shaped push end abutting engageably against said first movable pulley so that rotation of said operable knob results in swinging action of said U-shaped push end relative to said ends, which in turn, results in movement of said first movable pulley toward and away from said first fixed pulley.
